(19) United States
(12) Patent Application Publication
(10) Pub. No.: US 2006/0225071 A1
(43) Pub. Date: Oct. 5, 2006

(54) Mobile communications terminal having a security function and method thereof

(75) Inventor: Sung-Yeon Kim, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/386,741

(22) Filed: Mar. 23, 2006

(30) Foreign Application Priority Data
Mar. 30, 2005 (KR) 10-2005-0026705

(51) Int. Cl. G06F 9/445

(52) U.S. Cl. 717/174; 717/178

(57) ABSTRACT

A method of providing security to a mobile communications terminal, includes determining whether a downloaded program attempts to access a predetermined region of a memory during an installation of the downloaded program, and aborting installation of the downloaded program if the downloaded program attempts to access the predetermined region of memory during the installation of the downloaded program.

This application claims the benefit of Korean Application No. 10-2005- 0026705, filed on Mar. 30, 2005, which is hereby incorporated by reference in its entirety.

### BACKGROUND OF THE INVENTION

1. Field of the Invention

The present invention relates to a mobile communications terminal, and particularly, to a mobile communications terminal having a security function which protects a predetermined region of memory from an unauthorized program, and a method thereof.

2. Description of the Background Art

In general, a mobile communications terminal is a communication device capable of making a wireless phone call or providing a wireless data connection. Typically, a mobile communications terminal communicates with a wireless network by establishing a wireless connection between the mobile communications terminal and one or more Base Stations (BS). Switching control for the wireless connection is typically performed by a Mobile Switching Center (MSC). A mobile communication terminal can use the wireless connection for voice communications, data communications (such as for communicating symbols, numbers, characters, or the like), and multimedia communications (such as for communicating images and videos).

Some mobile communications terminals can now provide wireless Internet access. To obtain wireless Internet access, a mobile communication terminal typically is required to log into an access server. Via the wireless Internet access, a user can easily request and download software programs which he desires.

A typical mobile communications terminal may use anti-virus software to protect itself from software programs infected with a computer virus. However, anti-virus software may not provide sufficient protection from some viruses, thus leaving the mobile communications terminal vulnerable to damage.

Accordingly, it very difficult to protect sensitive areas of memory of a related art mobile communication terminal, such as regions of memory which store an operating system (OS), from unauthorized programs such as viruses downloaded from the Internet.

### SUMMARY OF THE INVENTION

In view of the foregoing, the present invention, through one or more of its various aspects, embodiments, and/or specific features or sub-components, is thus intended to bring out one or more of the advantages as specifically noted below.

An object of the present invention is to provide a mobile communications terminal having a security function which protects a predetermined region of memory from an unauthorized program by preventing the program from accessing the predetermined region of memory, and a method thereof.

To achieve at least the above object, there is provided a method of providing security to a mobile communications terminal which includes determining whether a downloaded program attempts to access a predetermined region of a memory during an installation of the downloaded program, and aborting installation of the downloaded program if the downloaded program attempts to access the predetermined region of memory during the installation of the downloaded program.

The memory may include a flash memory, and the predetermined region of memory may include a region of memory where an operating system is stored. The method may also include performing a procedure to download a program from a machine. The machine may include one of a file server, a computer, and another mobile communications terminal.

The procedure to download the program from the machine may include determining whether a user requests that a program be downloaded, determining whether an identifier of the machine is included in a predetermined list when the user requests that the program be downloaded, and denying the request to download the program if the identifier of the machine is included in the predetermined list. The identifier of the machine may include an IP address.

The method may also include displaying a message which notifies a user that the request to download the program has been denied. The predetermined list may contain identifiers of machines registered as being sources of a virus.

The method may also include downloading the requested program if the identifier of the machine is not included in the predetermined list. Denying the request to download the program may include informing the user that the identifier of the machine is included in the predetermined list, determining whether a user wishes to download the requested program after the user is informed that the identifier of the machine is included in the predetermined list, and not downloading the requested program if it is determined that the user does not wish to download the requested program.

The method may include completing the installation of the downloaded program if the downloaded program does not attempt to access the predetermined region of memory during the installation. The method may also include adding an identifier of a machine from which the program was downloaded to a predetermined list if the program attempts to access the predetermined region of a memory during the installation of the downloaded program, and displaying a message which notifies a user that the installation of the downloaded program has been aborted, if the installation of the downloaded program has been aborted.

According to another aspect, there is also provided a method of providing security to a mobile communications terminal which includes determining whether a program attempts to access a predetermined region of a memory during an execution of the program, and aborting the execution of the program if the program attempts to access the predetermined region of the memory during the execution of the program. The memory may include a flash memory, and the predetermined region may include a region where an operating system is stored.

According to another aspect, there is also provided a mobile communications terminal having a security function which includes a controller that determines whether to abort an installation of a downloaded program, and a memory that stores an identifier of a machine from which the downloaded program has been downloaded.

The terminal may also include a display for displaying a result of an attempted program download. The controller may abort the installation of the downloaded program when the downloaded program attempts to access a predetermined region of memory during the installation of the downloaded program. The predetermined region of memory may include a region of memory which stores an operating system, and the memory may include a flash memory.

The controller may add the identifier of the machine to a predetermined list in the memory when the downloaded program attempts to access a predetermined area of memory. The predetermined list may contain identifiers of machines registered as being sources of a virus.

According to another aspect, there is also provided a mobile communications terminal having a security function which includes a controller that determines whether to abort an execution of a downloaded program, and a memory that stores an identifier of a machine from which the downloaded program has been downloaded. The controller may abort an execution of the downloaded program when the downloaded program attempts to access a predetermined region of memory during the execution of the downloaded program.

According to another aspect, there is also provided a computer-readable medium which includes a program for providing security to a mobile communications terminal. The program includes code that determines whether a downloaded program attempts to access a predetermined region of a memory during an installation of the downloaded program, and code that aborts installation of the downloaded program if the downloaded program attempts to access the predetermined region of memory during the installation of the downloaded program.

According to another aspect, there is also provided a computer-readable medium which includes a program for providing security to a mobile communications terminal. The program includes code that determines whether a program attempts to access a predetermined region of a memory during an execution of the program, and code that aborts the execution of the program if the program attempts to access the predetermined region of the memory during the execution of the program.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is a schematic view showing an embodiment of a construction of a mobile communications terminal having a security function;

FIG. 2 is a flow chart showing an embodiment of a method of providing security to a mobile communications terminal;

FIG. 3A is a flow chart showing an embodiment of a method for downloading a program to a mobile communications terminal;

FIG. 3B is a flow chart showing another embodiment of a method for downloading a program to a mobile communications terminal; and

FIG. 4 is a flow chart showing another embodiment of a method of providing security to a mobile communications terminal.

### DETAILED DESCRIPTION OF THE PREFERRED EMBODIMENTS

Reference will now be made in detail to the preferred embodiments of the present invention, examples of which are illustrated in the accompanying drawings.

Hereinafter, with reference to the attached drawings, explanations will be provided for preferred embodiments of a mobile communications terminal having a security function capable of protecting sensitive areas of memory of the mobile communication terminal from an unauthorized program by preventing the program from accessing a predetermined region in memory while it is being installed or executed, and a method thereof.

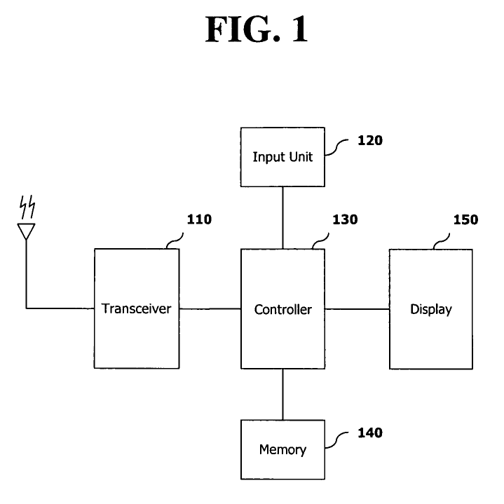

FIG. 1 is a schematic view showing an embodiment of a mobile communications terminal having a security function.

As shown in FIG. 1, a mobile communications terminal having a security function includes a transceiver 110 capable of downloading a program, an input unit 120 which allows a user to control the mobile communications terminal, a controller 130 capable of preventing an installation or execution of the downloaded program, a memory 140 capable of storing an identifier which identifies the source of the downloaded program, and a display 150 capable of displaying a result of the program download. The identifier which identifies the source of the downloaded program may be, for example, an Internet Protocol (IP) address of a file server from which the program was downloaded.

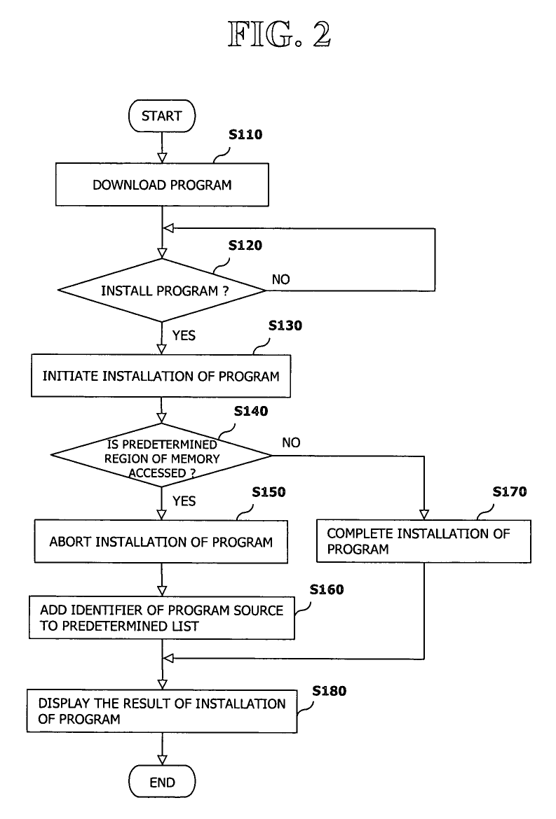

FIG. 2 is a flow chart illustrating a method of providing security to a mobile communications terminal.

FIG. 2 illustrates an embodiment of a method of providing security to a mobile communications terminal which includes: downloading a program (S110); determining whether the downloaded program is to be installed (S120); initiating installation of the downloaded program according to the result of the determination (S130); determining whether the program attempts to access a predetermined region of a memory (S140); aborting the installation of the program when the program attempts to access the predetermined region of memory (S150); adding an identifier which identifies the source of the downloaded program to a predetermined list (S160); and displaying the result of the program installation (S180). Here, the mobile communications terminal completes the installation of the program when the program does not attempt to access the predetermined region of memory (S170).

According to one embodiment, the memory can be a flash memory. According to another embodiment, the predetermined memory region which is protected may be a region of memory in which an operating system (OS) of the mobile communications terminal is installed. The predetermined list may be a database which stores identifiers (such as IP addresses) of machines which the mobile communications terminal registers as sources of viruses.

An embodiment of a method of providing security to a mobile communications terminal will now be explained in detail.

First, a mobile communications terminal establishes a connection with a machine from which a user wishes to download a software program. Non-limiting examples of such a machine include a file server, a computer, or another mobile communications terminal. If the mobile communications terminal attempts to connect to a file server to download a software program, this typically involves logging into an access server first to establish a wireless Internet connection.

After the mobile communication terminal establishes a connection with the machine, the mobile communications terminal sends a request to the machine to download a specific program. In response to the request, the machine transmits the requested program to the mobile communications terminal, which is received by the mobile communication terminal transceiver 110 (S110). If the mobile communications terminal is connected to the machine via an access server and downloads the program through the access server, the access server may optionally scan the program for viruses and inform the mobile communications terminal user of the results of the virus scan before forwarding the program to the mobile communications terminal, thus providing the user with the option to abort the download before the program is received by the transceiver 110.

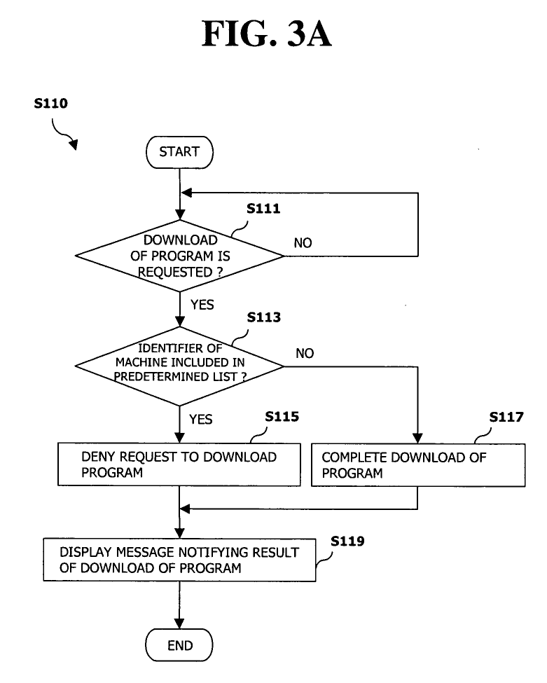

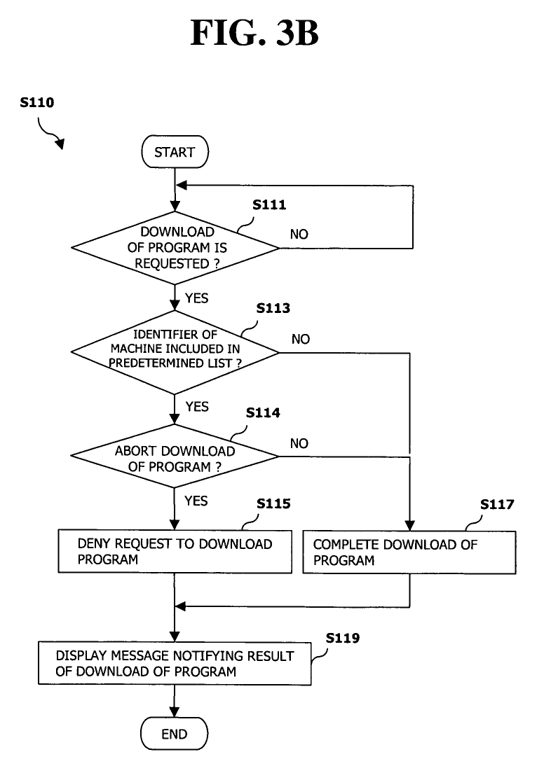

An embodiment of the step S110 of downloading a program is explained below with reference to FIG. 3A.

FIG. 3A illustrates an embodiment of a method for downloading a program from a machine to a mobile communications terminal which includes: determining whether a user has requested that a program be downloaded (S111); determining whether an identifier of the machine is included in a predetermined list (S113); denying the request to download the program if the identifier is included in the predetermined list (S115); and displaying a message notifying a user of the result of the attempted download (S119). If the identifier of the machine is not included in the predetermined list, the program is downloaded to the mobile communications terminal (S117).

The above-noted method for downloading a program to a mobile communications terminal is now described in detail.

First, the controller 130 determines whether the user has requested that a program be downloaded (S111). When the download of the program is requested, the mobile communications terminal determines whether an identifier of the machine providing the program to be downloaded is included in the predetermined list stored in the memory 140 (S113).

The controller 130 denies the request to download the program if the identifier of the machine is included in the predetermined list (S115), and accepts the request and downloads the requested program via the transceiver 110 if the identifier of the machine is not included in the predetermined list (S117).

The mobile communications terminal then displays a message notifying the result of the download of the program on the display 150 (S119).

FIG. 3B illustrates another embodiment of a method for downloading a program to the mobile communications terminal. The method illustrated in FIG. 3B is similar to the method illustrated in FIG. 3A, thus steps previously described above with respect to FIG. 3A are not described here again in detail. The method of FIG. 3B differs from the method of FIG. 3A in that it includes an additional step (S114) which allows a user to determine whether a program should be downloaded even if an identifier of the machine from which the software is to be downloaded is included in the predetermined list. For example, the user may be queried by the terminal, and allowed to select whether to abort or to continue with the download. As with other user interactions, such query and selection can be performed via the display 150 and input unit 120.

Referring again to FIG. 2, after a program has been downloaded, the controller 130 determines whether a request has been made to install the downloaded program (S120), and initiates the installation of the program when the installation of the downloaded program is requested (S130).

The controller 130 determines whether the downloaded program attempts to access the predetermined region in the memory during installation (S140). If the program attempts to access the predetermined region, such as a region of memory where the operating system of the mobile communications terminal is stored, the controller 130 can prevent such access.

Accordingly, the controller 130 aborts the installation of the program if the program attempts to access the predetermined region of memory (S150), and adds the identifier identifying the source of the program (such as the IP address of a machine from which the program was downloaded) to the predetermined list (S160). Conversely, when the program does not attempt to access the predetermined region of memory, the mobile communications terminal completes installation of the program (S170).

As a result, as the mobile communications terminal displays a message notifying the result of the installation of the program on the display 150 (S180), the user can take an appropriate action thereafter. That is, the user preferably deletes the program if the mobile communications terminal has aborted its installation because it has attempted to access the predetermined region of memory.

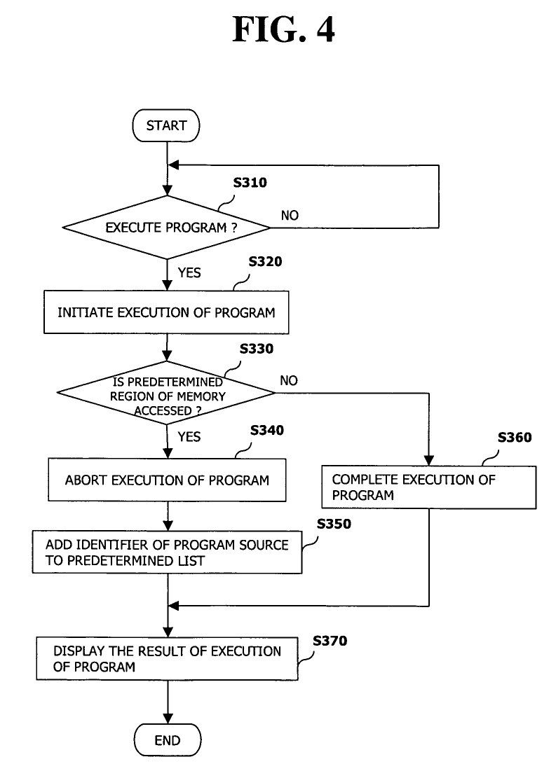

FIG. 4 illustrates another embodiment of a method of providing security to a mobile communications terminal.

The method illustrated in FIG. 4 is similar to the method illustrated in FIG. 2; however, in the method of FIG. 4, a security function goes into effect when a downloaded program is executed, rather than, or in addition to, when a downloaded program is installed.

That is, FIG. 4 illustrates an embodiment of a method of providing security to a mobile communications terminal which includes: determining whether a downloaded program is to be executed (S310); initiating execution of the downloaded program according to the result of the determination (S320); determining whether the program attempts to access a predetermined region a memory (S330); aborting the execution of the program when the program attempts to access the predetermined region of memory (S340); adding an identifier which identifies the source of the downloaded program to a predetermined list (S350); and displaying the result of the program execution (S370). Here, the mobile communications terminal completes the execution of the program when the program does not attempt to access the predetermined region of memory (S360).

Thus, described above is a mobile communications terminal having a security function, which prevents a program which has been downloaded, such as via a wireless Internet connection, from accessing predetermined regions of a memory when the program is installed or executed. As a result, sensitive areas of memory, such as those areas which store an operating system of a mobile communications terminal, can be better protected from damage caused by unauthorized software programs.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

In an embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing.

The present disclosure contemplates a computer-readable medium that includes instructions or receives and executes instructions responsive to a propagated signal. The term “computer-readable medium” shall include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. As the present invention may be embodied in several forms without departing from the spirit or essential characteristics thereof, it should also be understood that the above-described embodiments are not limited by any of the details of the foregoing description, unless otherwise specified. Rather, the above-described embodiments should be construed broadly within the spirit and scope of the present invention as defined in the appended claims. Therefore, changes may be made within the metes and bounds of the appended claims, as presently stated and as amended, without departing from the scope and spirit of the invention in its aspects.

What is claimed is:

1. A method of providing security to a mobile communications terminal, comprising:
determining whether a downloaded program attempts to access a predetermined region of a memory during an installation of the downloaded program; and
aborting installation of the downloaded program if the downloaded program attempts to access the predetermined region of memory during the installation of the downloaded program.

2. The method according to claim 1, wherein the memory comprises a flash memory.

3. The method according to claim 1, wherein the predetermined region of memory comprises a region of memory where an operating system is stored.

4. The method according to claim 1, further comprising performing a procedure to download a program from a machine.

5. The method according to claim 4, wherein the machine comprises one of a file server, a computer, and another mobile communications terminal.

6. The method according to claim 4, wherein the procedure to download the program from the machine comprises:
determining whether a user requests that a program be downloaded;
determining whether an identifier of the machine is included in a predetermined list when the user requests that the program be downloaded; and
denying the request to download the program if the identifier of the machine is included in the predetermined list.

7. The method according to claim 6, wherein the identifier of the machine comprises an IP address.

8. The method according to claim 6, further comprising displaying a message which notifies a user that the request to download the program has been denied.

9. The method according to claim 6, wherein the predetermined list contains identifiers of machines registered as being sources of a virus.

10. The method according to claim 6, further comprising downloading the requested program if the identifier of the machine is not included in the predetermined list.

11. The method according to claim 10, wherein denying the request to download the program comprises:
informing the user that the identifier of the machine is included in the predetermined list;
determining whether a user wishes to download the requested program, after the user is informed that the identifier of the machine is included in the predetermined list; and
not downloading the requested program if it is determined that the user does not wish to download the requested program.

12. The method according to claim 1, further comprising completing the installation of the downloaded program if the downloaded program does not attempt to access the predetermined region of memory during the installation.

13. The method according to claim 1, further comprising:
adding an identifier of a machine from which the program was downloaded to a predetermined list if the program attempts to access the predetermined region of a memory during the installation of the downloaded program; and
displaying a message which notifies a user that the installation of the downloaded program has been aborted, if the installation of the downloaded program has been aborted.

14. A method of providing security to a mobile communications terminal, comprising:
determining whether a program attempts to access a predetermined region of a memory during an execution of the program; and
aborting the execution of the program if the program attempts to access the predetermined region of the memory during the execution of the program.

15. The method according to claim 14, wherein the memory comprises a flash memory.

16. The method according to claim 14, wherein the predetermined region comprises a region where an operating system is stored.

17. A mobile communications terminal having a security function, comprising:
a controller that determines whether to abort an installation of a downloaded program; and
a memory that stores an identifier of a machine from which the downloaded program has been downloaded.

18. The terminal according to claim 17, further comprising a display for displaying a result of an attempted program download.

19. The terminal according to claim 17, wherein the controller aborts the installation of the downloaded program when the downloaded program attempts to access a predetermined region of memory during the installation of the downloaded program.

20. The terminal according to claim 19, wherein the predetermined region of memory comprises a region of memory which stores an operating system.

21. The terminal according to claim 17, wherein the memory comprises a flash memory.

22. The terminal according to claim 21, wherein the controller adds the identifier of the machine to a predetermined list in the memory when the downloaded program attempts to access a predetermined area of memory.

23. The terminal according to claim 22, wherein the predetermined list contains identifiers of machines registered as being sources of a virus.

24. A mobile communications terminal having a security function, comprising:
a controller that determines whether to abort an execution of a downloaded program; and
a memory that stores an identifier of a machine from which the downloaded program has been downloaded.

25. The terminal according to claim 24, wherein the controller aborts an execution of the downloaded program when the downloaded program attempts to access a predetermined region of memory during the execution of the downloaded program.

26. A computer-readable medium comprising a program for providing security to a mobile communications terminal, the program comprising:
code that determines whether a downloaded program attempts to access a predetermined region of a memory during an installation of the downloaded program; and
code that aborts installation of the downloaded program if the downloaded program attempts to access the predetermined region of memory during the installation of the downloaded program.

27. A computer-readable medium comprising a program for providing security to a mobile communications terminal, the program comprising:
code that determines whether a program attempts to access a predetermined region of a memory during an execution of the program; and
code that aborts the execution of the program if the program attempts to access the predetermined region of the memory during the execution of the program.
